(19) United States
(12) Patent Application Publication
(10) Pub. No.: US 2002/0109990 A1
(43) Pub. Date: Aug. 15, 2002

(54) Decorative light plug

(76) Inventor: Tsui-Tuan Fan Wong, Hsitzu City (TW)

Correspondence Address: Alan Kamrath, RIDER BENNETT EGAN & ARUNDEL, LLP, Suite 2000, 333 South Seventh Street, Minneapolis, MN, 55402, US

(21) Appl. No.: 09/784,775

(22) Filed: Feb. 15, 2001

(51) Int. Cl. H01R 33/00

(52) U.S. Cl. 362/226; 362/551; 362/806

(57) ABSTRACT

A decorative light plug has a female connector integrally formed on the decorative light and a cover. A flange is formed on an outer periphery of the female connector. The cover has a blind hole defined to enclose a distal end of the decorative light, a pair of keyways formed in the blind hole to correspond to a pair of keys formed on the outer periphery of distal end of the female connector and an annular groove defined to correspond to the flange on the female connector. After the distal end of the decorative light is pressed into the blind hole of the cover, the flange is received in the annular groove. A ring outside the cover facilitates the detachment of the cover from the female connector.

### BACKGROUND OF THE INVENTION

1. Field of the Invention

The present invention relates to a decorative light plug, and more particularly to a decorative light plug detachably connected with a distal end of the decorative light so as to protect the distal end of the decorative light from damage.

2. Description of Related Art

A kind of light is made by numerous small light sources connected in series and coated with flexible and transparent plastic material so that it can send out soft light and provide a decorative effect. Since the light sources are connected in parallel, it is important to provide a secure connection between adjacent lights. With reference to FIG. 3, a conventional decorative light plug (4) is integrally formed on a distal end of the decorative light to protect the connection between adjacent lights (not shown) inside the decorative light from damage. When the decorative light of this kind is to be extended, the user will have to cut off the plug (4) and reconnect the distal end of the decorative light with a distal end of another decorative light, which is not only troublesome, but also a waste of material.

To overcome the shortcomings, the present invention tends to provide an improved decorative light plug to mitigate and obviate the aforementioned problems.

### SUMMARY OF THE INVENTION

The primary objective of the invention is to provide an improved decorative light with a plug detachably connected to the decorative light. The plug has a collar slidably retained on the decorative light and a cover detachably connected with the collar, such that when the decorative light is not in use, the cover is able to connect with the collar to protect the distal end of the decorative light from damage.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the decorative light plug in accordance with the present invention together with the decorative light;

FIG. 2 is a side view in partial cross section of the decorative light plug in FIG. 1 showing the engagement between the cover and the collar; and

FIG. 3 is a perspective view of a conventional decorative light plug.

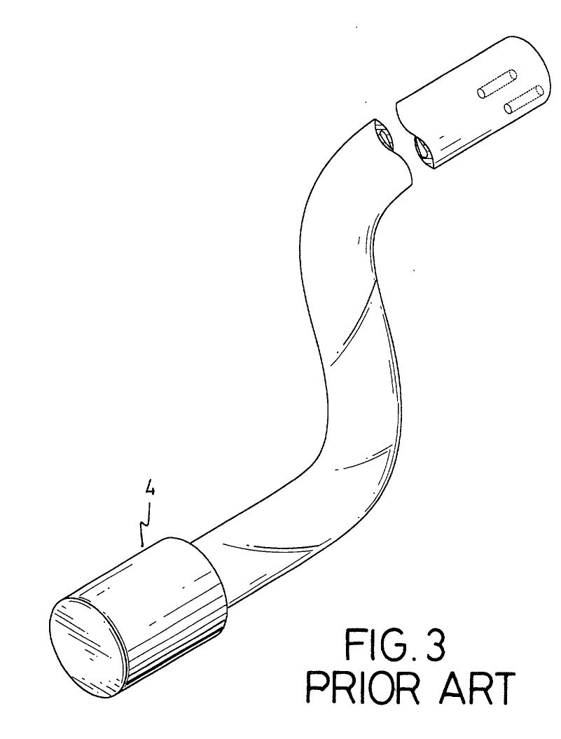

### DETAILED DESCRIPTION OF PREFERRED EMBODIMENT

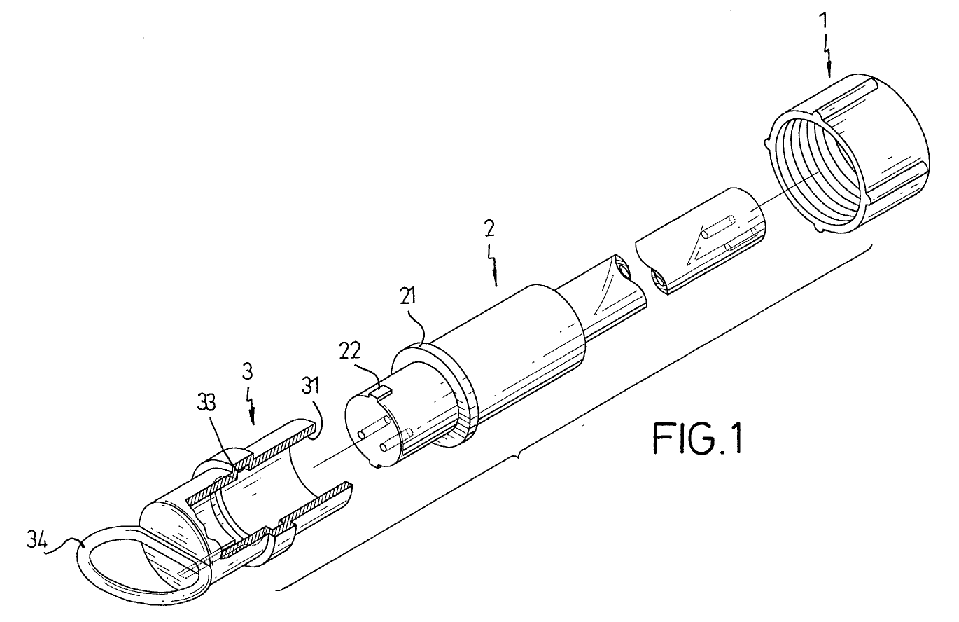

With reference to FIG. 1, the decorative light plug has a collar (1), a female connector (2) and a cover (3).

The collar (1) has a through hole (11) defined through the collar (1) and a tapered inner thread (12). The collar (1) is slidably retained on the decorative light. The collar (1) is used to securely attach a connector (not shown) to the female connector (2).

The female connector (2) is integrally formed on a distal end of the decorative light and has a flange (21) formed on an outer periphery of the decorative light and a pair of keys (22) formed on opposite sides of the distal end of the female connector (2).

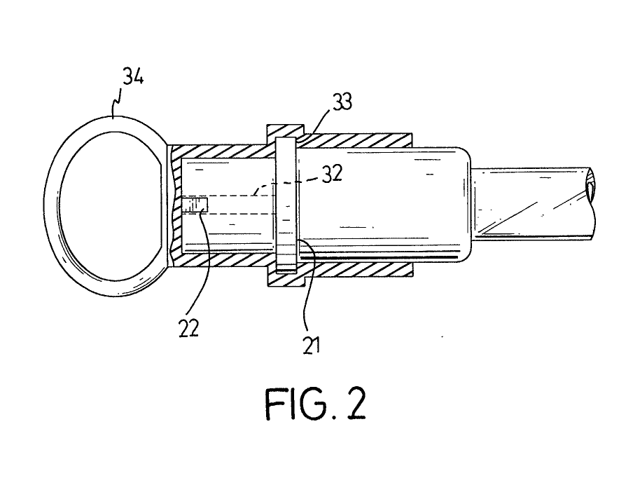

The cover (3) has a blind hole (31) defined to enclose the distal end of the decorative light, a pair of keyways (32) corresponding to the keys (22), as shown in FIG. 2, an annular groove (33) defined to correspond to the flange (21) of the female connector and a ring (34) formed outside the cover (3).

When the decorative light of the invention is not in use, the user engages the cover (3) with the decorative light by inserting the keys (22) into the corresponding keyways (32). After the keys (22) are completely pressed into the keyways (32), the flange (21) rests in the annular groove (33) so that the engagement between the female connector (2) and the cover (3) is secure and the distal end of the decorative light is protected. When the decorative light is to be connected with another decorative light, the user removes the cover (3) by pulling the ring (34) to release the annular groove (33) from the flange (21) to remove the cover (3) from the distal end of the decorative light.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A plug for a decorative light comprising:
a female connector integrally formed on a distal end of the decorative light and having a flange formed on an outer periphery of the female connector; and
a cover having a blind hole defined to enclose a distal end of the decorative light and an annular groove defined to correspond to the flange of the female connector,
whereby after the female connector is pressed into the blind hole, the flange of the female connector is held by the annular groove of the cover so that the engagement between the cover and the decorative light is secure.

2. The plug as claimed in claim 1, wherein the female connector further has a pair of keys formed on opposite sides of the distal end of the female connector and the cover further has a pair of keyways defined to correspond to the keys on the female connector.

3. The plug as claimed in claim 2, wherein the cover further has a ring formed outside the cover, to facilitate disconnecting the cover from the female connector.
